(19) United States
(12) Patent Application Publication
(10) Pub. No.: US 2018/0246621 A1
(43) Pub. Date: Aug. 30, 2018

(54) Hierarchically displayed timelines of file system references and links to electronic artifacts retrievable from a non-transitory storage medium

(71) Applicant: DEAN DRAKO, AUSTIN, TX (US)

(72) Inventor: DEAN DRAKO, AUSTIN, TX (US)

(21) Appl. No.: 15/443,662

(22) Filed: Feb. 27, 2017

(51) Int. Cl. G06F 3/0482; G06F 3/0484; G06F 3/0481; G06F 17/30

(52) U.S. Cl. CPC G06F 3/0482; G06F 3/04847; G06F 17/30126; G06F 17/30221; G06F 3/04817

(57) ABSTRACT

A hierarchical graphical user interface enables selection of time scopes and icons in a horizontal display which expands into a timeline of selectable icons linked to electronic artifacts. A hierarchical file system catalog (directory and sub-directories) of file references displays as a plurality of horizontal or vertical timelines populated by icons for electronic artifacts in increasing or decreasing time order. A catalog of file system objects related to location, file organization, subject matter, or application transforms into a channel having at least one time attribute. Each channel has a timespan which bounds the earliest and latest time attribute of referenced objects set by access history, tags, personal statistics or user action. New channels and timespans of references are based on datetimes, tags, content, or other meta data such as relationships among users, GPS coordinates, or key images and binary strings.

### CROSS-REFERENCES TO RELATED APPLICATIONS

NONE.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

A method improves the operation of a computer system and performs a user interface process to access non-transitory media which adds organization by time attributes.

### Description of Related Art

As is known, catalogs of files on computer systems are represented as a hierarchy of directories. A graphical user interface is often used to display these in different formats such as folders. Hierarchical, image view, and lists are common display formats known to the art. There is a desire to sometimes see these files in a historical display.

Conventional file systems are curated by a user or editor by manual assignment of files into a system of hierarchical directories and sub-directories which are catalogs organized by the curator's view of relationships among the files. These are frequently displayed graphically as named folders and sub-folders.

However, the graphical organization may not facilitate access by another user or even serve a divergent requirement particularly when a folder is simply another filename which depends on some intelligible naming convention. If this naming convention of folders is forgotten by the user or never known to a different user, it becomes hard to navigate the directories.

Conventional systems only allow users to operate on file access control records by sorting or filtering by datetime, filenames, or filekind (eg.extension). However typical display limitations require an interactive user to scroll through many lines of text or many images to see a desired file object. Thus both organizing and accessing files in a large archive is tedious and frustrating especially over long periods of usage when the user may have changed perspectives.

In particular what is needed is a graphical representation of date ranges and display via a timeline of related files and electronic artifacts which can impart much more information quickly.

### BRIEF SUMMARY OF THE INVENTION

A timeline is a display of a grouping of graphical representations based on: for example, a time element including day of week, week of year, month of year, calendar or fiscal years, centuries. A timeline may be a display of a grouping based on tagging of the referenced electronic artifacts or another abstract grouping concept. The display shows the representations in chronologic order reflecting the intuition of the user e.g. each newer pairwise item to the right of the older item. Each graphical representation is a reference to an electronic artifact such as files, reports, image, video and sound recordings, and resource identifiers into a file system of non-transitory media.

A hierarchical user interface enables selection of time scopes and icons in a horizontal display which expands into a timeline of selectable icons linked to electronic artifacts. The method enables the user to set time ranges and view objects in a file system in a chronological order.

A display presents directories and sub-directories of file system organizations as a hierarchy of timelines whose start points and endpoints are arranged with respect to a calendar or time scale running horizontally or vertically.

Selecting a timeline corresponding to a directory causes the display to expand to show icons linked to electronic artifact locations in storage. The icons are also arranged with respect to a calendar or time scale running horizontally or vertically.

A timeline may also display another timeline corresponding to a subdirectory or any other grouping of graphical representations, icons, thumbnails, symbols, etc.

A method transforms a hierarchical file system catalog (directory) of file references into a plurality of horizontal or vertical display of timelines populated by icons for electronic artifacts in increasing or decreasing time order. Every reference to an electronic artifact has at least one time attribute which may position it relative to other electronic artifacts in a range of time attributes. The earliest and latest attribute among the electronic artifacts referenced in a directory determines the timespan of the directory.

A visual indicia is displayed with a icon for the timespan. A timeline with icons for electronic artifacts is displayed when a timespan is selected.

A method transforms a directory or sub-directory into a channel of references to file system objects having meta data related to at least one time attribute. Each channel has a timespan consisting of a start time and an endtime determined by the earliest and latest time attribute among its referenced file system objects.

The invention also creates timelines off of items that are not just in a directory or sub-directory, but entirely something abstract like a tag, keyword, event, or recognized pattern. Each channel has a timespan consisting of a start time and an endtime determined either by the earliest and latest time attribute among its referenced file system objects or by a user.

File system objects may be grouped based on different parameters, such as by decade, or month, or year, or by a non-time item like books, or life events, such as employment, parenting, education, holidays, and birth and death records in vital statistics agencies.

A method generates new channels and timespans of references based on tags, content, or other meta data related to electronic artifacts in the file system such as GPS coordinates, or key images and binary strings.

The primary function of the method organizes groups of items into a display of icons ranked by dates or datetimes.

Additionally, grouping the electronic artifacts by meta data that is within our system and not a part of the electronic artifacts utilizes for example, the relationships of the accounts to make a timeline of electronic artifacts based on the relationships.

A conventional directory tree data structure is transformed into a timeline display by determining a position for a start time by selecting the earliest time attribute among all the population of a directory or sub-directory and by determining a position for an endtime by selecting the latest time attribute among all the population of said directory or sub-directory.

When two time scopes have overlapping start times or endtimes, their timelines may be graphically displayed side by side, over/under, transparently, or slightly offset toward a receding horizon to be distinguishable. Time attributes may be creation date, modification date, last used date, derived from the content e.g. date of birth, death, marriage. Time attributes may be entered as meta data by a user or derived from contents of the file itself. Time attributes may be added by an application such as a version control or messaging system.

A method generates new channels and timespans of references based on tags, content, or other meta data related to electronic artifacts in the file system such as GPS coordinates, or key images and binary strings.

Authoring or application tools may add tags such as Global Positioning System (GPS) coordinates which suggest another directory or channel. Users may define channels according to subject matter, timespans, and geo-fences to which electronic artifacts may be associated. Timespans may be segmented to reduce clutter according to a maximum density.

### BRIEF DESCRIPTION OF DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of a processor suitable for performing method steps in an apparatus; FIGS. 2-10 are flowcharts of method step embodiments for transforming metadata about electronic artifacts encoded in non-transitory media and displaying graphical icons linked to storage locations and initiate appropriate applications; FIG. 11 illustrates inputs to a method, processes, and exemplary displays of outputs; and FIG. 12 is a three dimensional perspective view of the structure of the organization.

### DETAILED DESCRIPTION OF EMBODIMENTS OF THE INVENTION

All of the following transformations and logic operations are performed by an electronic circuit. As is known, image file data may be read and stored to non-transitory computer readable media and operated on by a processor controlled by instructions in a store.

A hierarchical user interface enables selection of time scopes and icons in a horizontal display which expands into a timeline of selectable icons linked to electronic artifacts. Electronic artifacts include files, reports, images, sound recordings, and resource identifiers. They are represented by icons organized in ascending or descending time order, which if selected launch a compatible application to open, play, or edit the electronic artifact.

Time scopes reference electronic artifacts within a range of times.

To avoid visual clutter, each timeline may display icons for sub-timelines when the number of electronic artifacts exceeds a threshold.

A method transforms a hierarchical file system catalog (directory) of file references into a plurality of horizontal or vertical display of timelines populated by icons for electronic artifacts in increasing or decreasing time order.

In one embodiment, icons referencing the most recent electronic artifacts are visually arranged rightmost and the oldest electronic artifacts are visually arranged leftmost. The length, width, or depth of indicia for each timescope is related to its timespan. The display position of each timescope is relative to the start time and endtime of every other timescope in the display.

A method transforms a directory or sub-directory into a channel of references to file system objects having meta data related to at least one time attribute. Each channel has a timespan consisting of a start time and an endtime determined by the earliest and latest time attribute among its referenced file system objects.

Each directory or sub-directory provides a default timescope having a timespan determined by metadata of the file objects referenced within the directory or sub-directory. Each timescope is displayed with an icon stretched from the earliest time attribute to the latest time attribute of file system objects referenced by the directory or sub-directory. A default display scales all timescopes to fit from earliest file metadata to the latest. Sub-timescopes are generated to scale to the display size.

A method generates new channels and timespans of references based on tags, content, or other meta data related to electronic artifacts in the file system such as GPS coordinates, or key images and binary strings. Automated filters organize electronic artifacts into a channel or a timespan based on geo-location, facial recognition, language, or pattern recognition. A minimum or maximum density of icons within a timespan causes regrouping into sub-channels.

Electronic artifacts having GPS coordinates are assigned to channels defined by a geo-fence. Electronic artifacts are associated with channel having similar content or subject matter. Electronic artifacts are grouped into user dimensioned timespans or default timespans based on user's personal milestones.

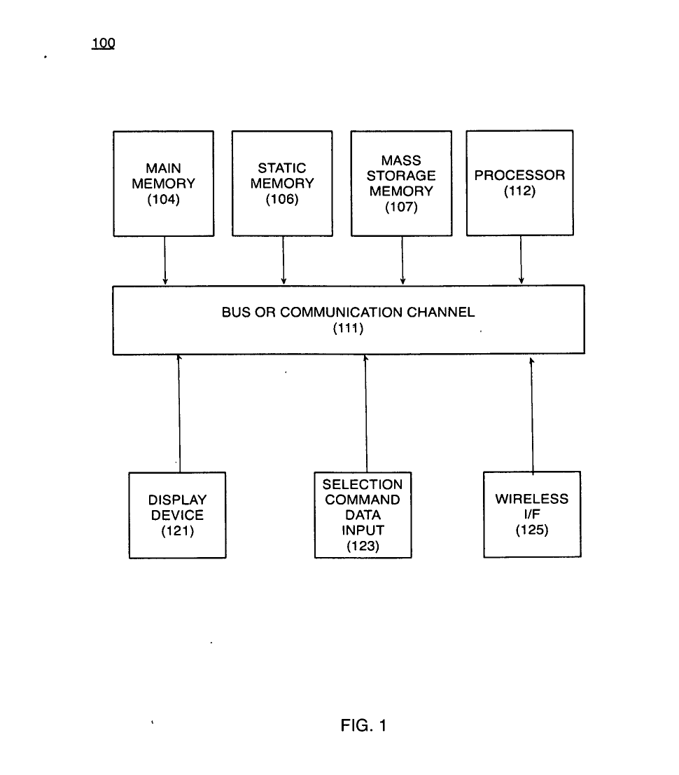

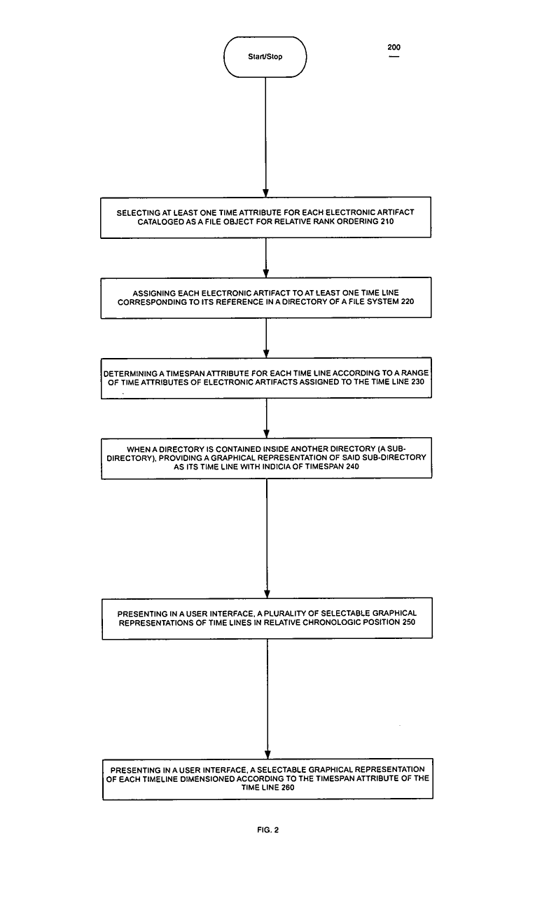

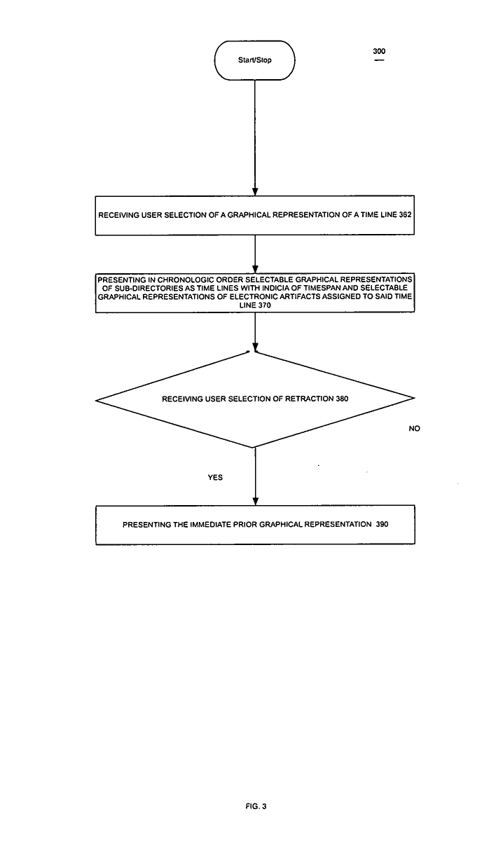

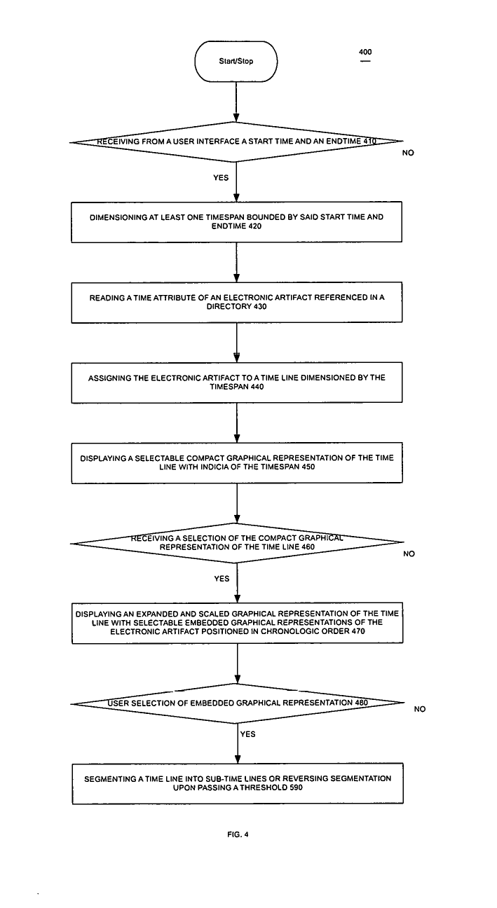

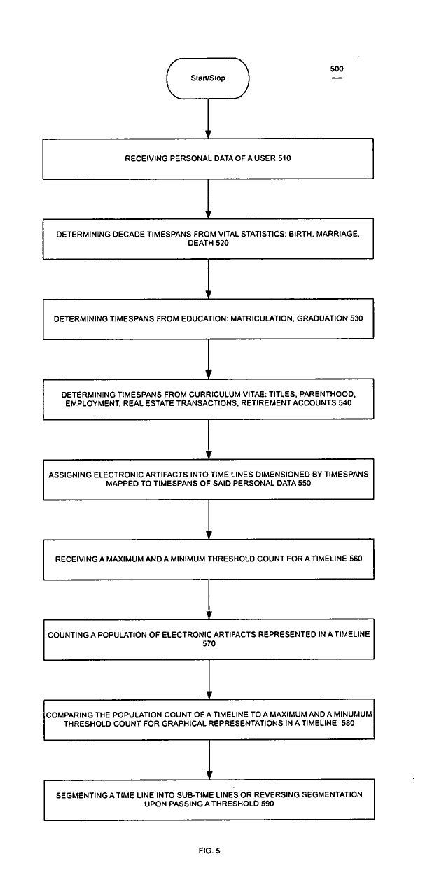

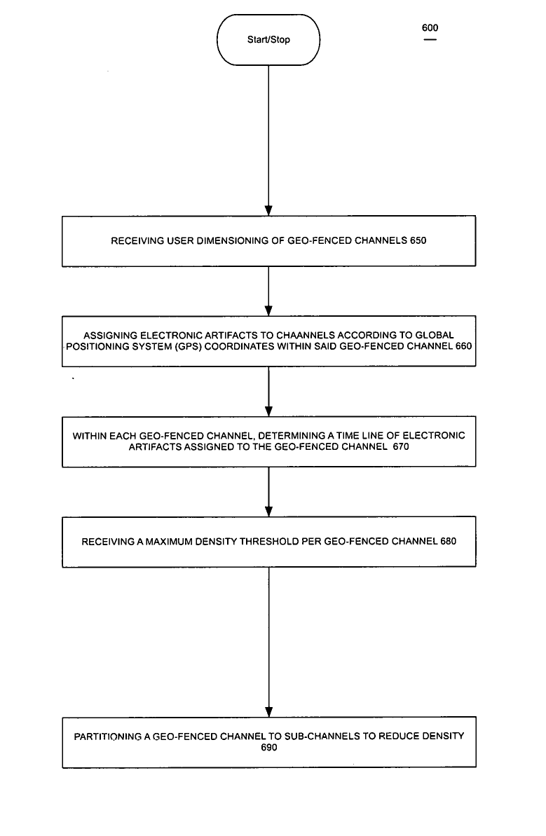

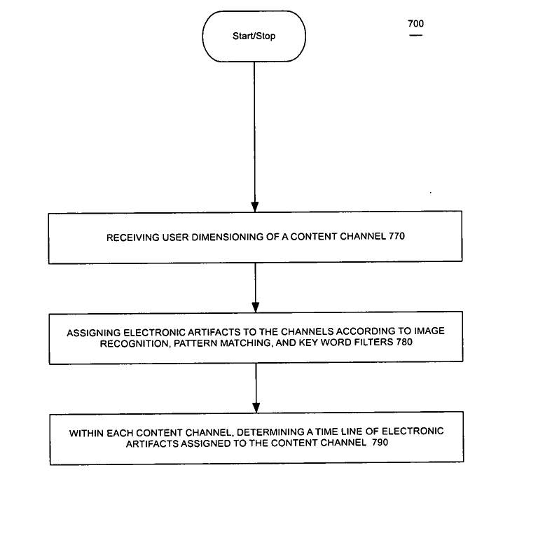

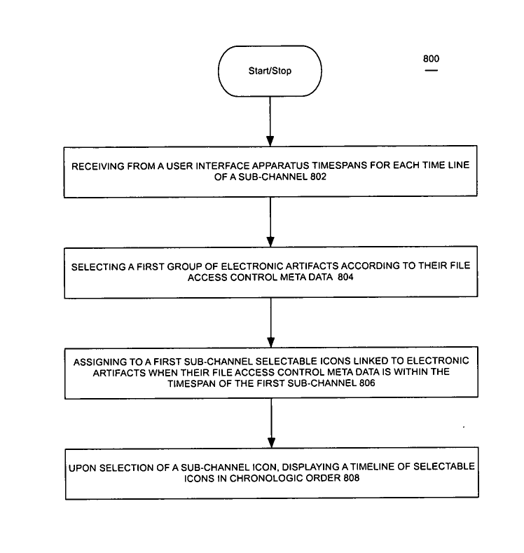

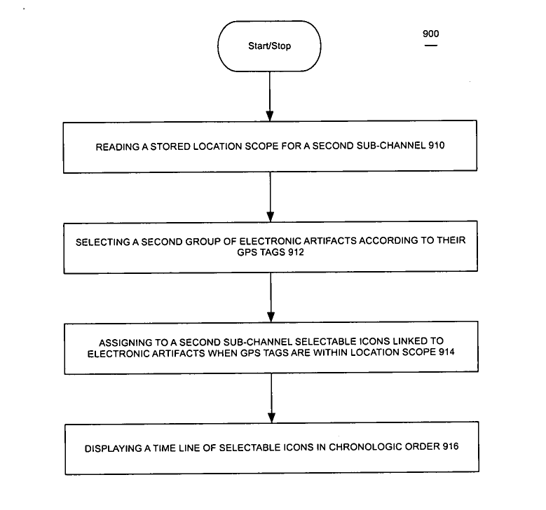

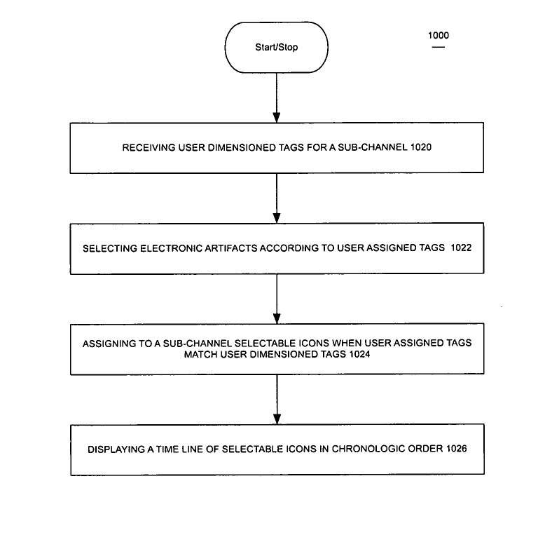

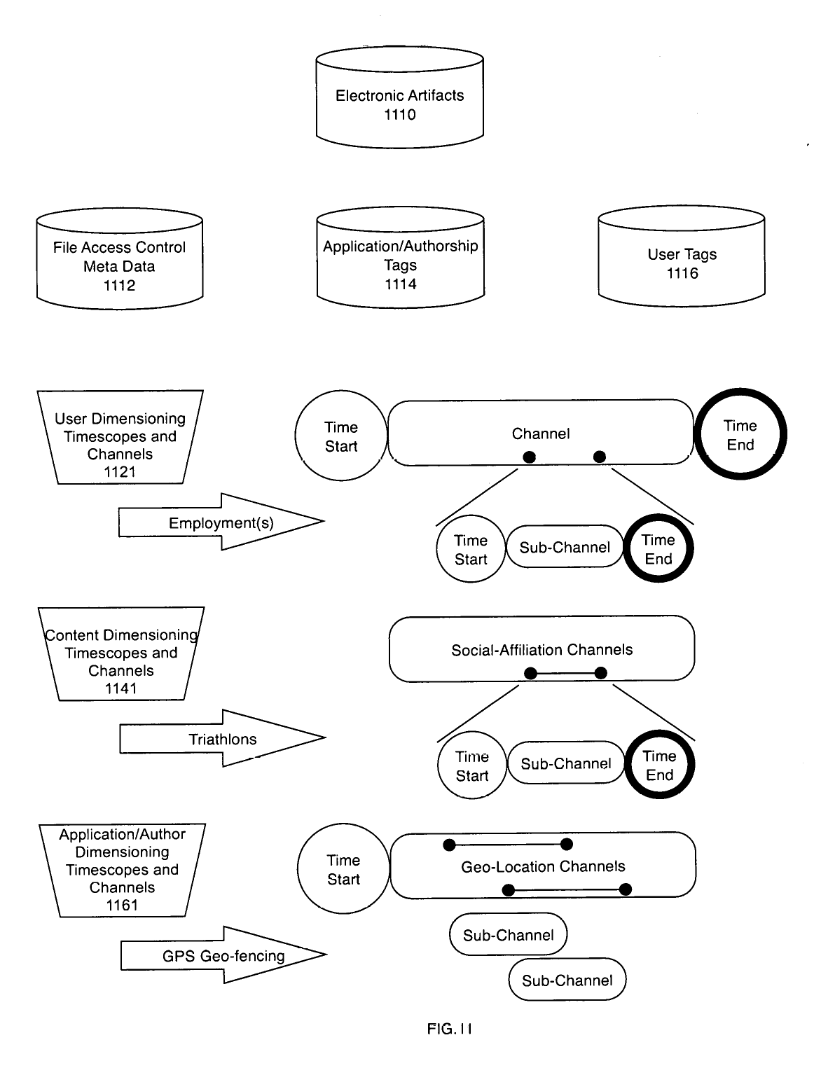

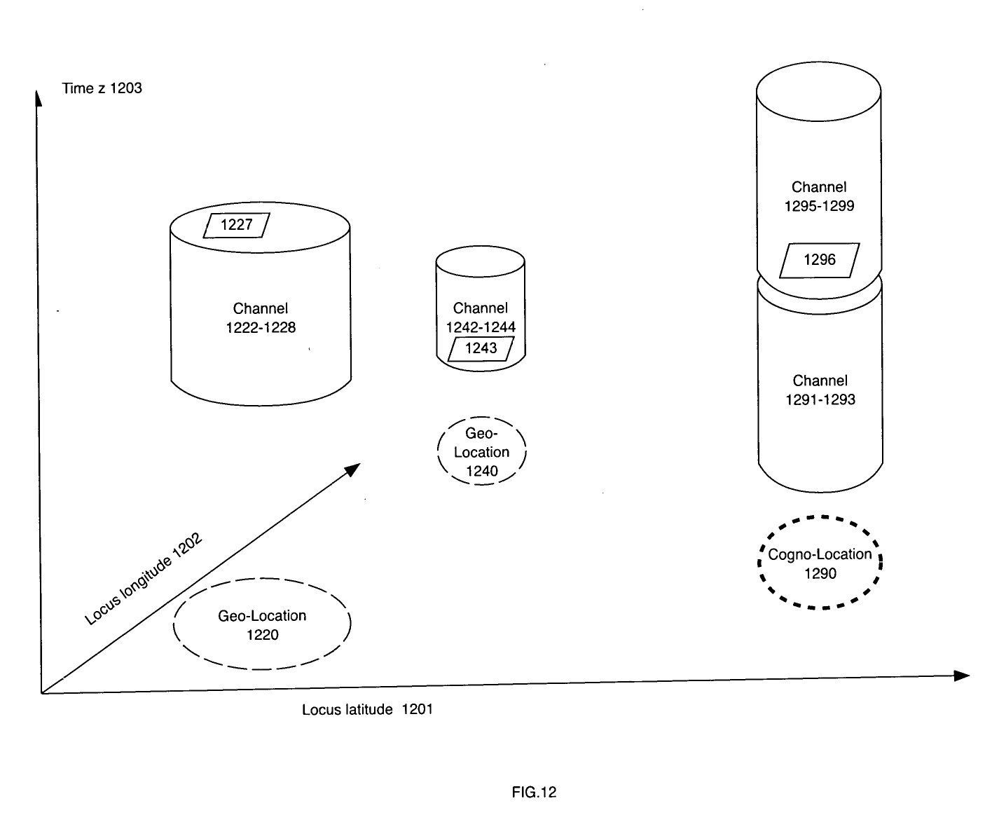

FIG. 1 is a block diagram of a processor apparatus suitable for performance of method steps of the invention to receive user input, to transform metadata on electronic artifacts in non-transitory storage media, and to display indicia on a user interface.

FIG. 2 is a flowchart of a first method 200 for displaying a catalog of electronic artifacts in a file system in hierarchical chronological sequence which includes: selecting at least one time attribute for each electronic artifact cataloged as a file object for relative rank ordering 210; assigning each electronic artifact to at least one timeline corresponding to its reference in a directory of the file system 220; determining a timespan attribute for each timeline according to a range of time attributes of electronic artifacts assigned to the timeline 230; when a directory is contained inside another directory (a sub-directory), providing a graphical representation of said sub-directory as its timeline with indicia of timespan 240; presenting in a user interface a plurality of selectable graphical representations of timelines in relative chronological position 250; and presenting in a user interface, a selectable graphical representation of each timeline dimensioned according to the timespan attribute of the timeline 260.

FIG. 3 is a flowchart of an embodiment 300 of the method including further steps: receiving user selection of a graphical representation of a timeline 362; presenting in chronologic order selectable graphical representations of sub-directories as timelines with indicia of timespan and selectable graphical representations of electronic artifacts assigned to said timeline 370; and upon receiving user selection of retraction 380, presenting the immediate prior graphical representation 390.

FIG. 4 is a flowchart of an embodiment 400 of the method including further steps: receiving from a user interface a start time and an endtime 410; dimensioning at least one timespan bounded by said start time and endtime 420; reading a time attribute of an electronic artifact referenced in a directory 430; assigning the electronic artifact to a timeline dimensioned by the timespan 440; displaying a selectable compact graphical representation of the timeline with indicia of the timespan 450; receiving a selection of the compact graphical representation of the timeline 460; displaying an expanded and scaled graphical representation of the timeline with a selectable embedded graphical representation of the electronic artifact positioned in chronological order 470; and upon receiving user selection of the embedded graphical representation 480, operating an application on the electronic artifact stored in non-transitory media 490.

FIG. 5 is a flowchart of an embodiment 500 of the method including further steps: receiving personal data of a user 510; determining timespans from vital statistics: birth, marriage, death 520; determining timespans from education: matriculation, graduation 530; determining timespans from curriculum vitae: titles, parenthood, employment change, real estate transactions, retirement accounts 540; assigning electronic artifacts into timelines dimensioned by timespans mapped to said personal data milestones 550; receiving a maximum and minimum threshold count for a timeline 560; counting a population of electronic artifacts represented in a timeline 570; comparing the population count of a timeline to a maximum and a minimum threshold count for graphical representations presented in a timeline 580; and segmenting a timeline into sub-timelines or reversing segmentation for visual comprehension upon passing a threshold count 590.

FIG. 6 is a flowchart of an embodiment 600 of the method including further steps: receiving user dimensioning of geo-fenced channels 650; assigning electronic artifacts to channels according to Global Positioning System (GPS) coordinates within said geo-fenced channel 660; within each geo-fenced channel, determining a timeline of electronic artifacts assigned to the geo-fenced channel 670; receiving a maximum density threshold per geo-fenced channel 680; and partitioning a geo-fenced channel to sub-channels to reduce density 690.

FIG. 7 is a flowchart of an embodiment 700 of the method including further steps: receiving user dimensioning of a content channel 770; assigning electronic artifacts to the channel according to image recognition, pattern matching, and key word filters 780; and within each content channel, determining a timeline of electronic artifacts assigned to the content channel 790.

FIG. 8 is a flowchart of a second method 800 for hierarchically displaying to a computer system user (user), a plurality of graphical representation of channels, a plurality of graphical representation of sub-channels, selectable icons and related executable links to storage locations in non-transitory media which includes the following steps: receiving from a user interface timespans for each timeline of a sub-channel 802; selecting a first group of electronic artifacts stored in non-transitory media according to their file access control meta data 804; assigning to a first sub-channel selectable icons linked to the first group of electronic artifacts when their file access control meta data is within the timespan of the first sub-channel 806; and upon selection of a sub-channel icon, displaying a timeline of selectable icons in chronologic order 808.

FIG. 9 is a flowchart of additional method steps 900 of the second method: reading a stored location scope for a second sub-channel 910; selecting a second group of electronic artifacts stored in non-transitory media according to their gps tags 912; and assigning to a second sub-channel selectable icons linked to the second group of electronic artifacts when their gps tags are within the range of the location scope of the second sub-channel 914; and displaying a timeline of selectable icons in chronologic order 916.

FIG. 10 is a flowchart of additional method steps 1000 of the second method: receiving user dimensioned tags for a third sub-channel 1020; selecting a third group of electronic artifacts stored in non-transitory media according to user assigned tags associated with the electronic artifact 1022; assigning to a third sub-channel selectable icons linked to the third group of electronic artifacts when their user assigned tags match a user dimensioned tags 1024; and displaying a timeline of selectable icons in chronologic order 1026.

FIG. 11 illustrates the transformation by a processor of electronic artifacts and their respective meta data, application/authorship tags, and user tags into selectable graphical representations on a display device. Electronic artifacts, stored in non-transitory media 1110 have file access control meta data 1112 and other datetime attributes. These include most recent use, time of creation, time of version control as examples. Any of these time attributes may be selected as an ordering system. A process 1121 may order these time attributes within timescopes and within channel of one type or another according to user dimensioning. In the illustration, electronic artifacts associated with one or more employments are assigned to a channel between a start time and an end time. A number of these electronic artifacts fall between a start time and an end time of a sub-channel, perhaps a specific profession, role, or enterprise.

Another channel may be dimensioned according to content for social or affiliation orientation and electronic artifacts are assigned to timescopes and channel 1141 such as a hobby of participating in Triathlons. Triathlon sub-channels are seasonal and probably overlap employments in timescopes. An affiliation may not have any particular start time or end time and be dimensioned according to electronic artifacts assigned to it.

Another channel may be dimensioned according to geo-locations 1161. Electronic artifacts assigned by application tags to GPS geo-fencing channels may be automatically assigned to sub-channels that overlap in time but not in space. Start time for such a channel is dimensioned by the contents assigned into it. As can be appreciated, hierarchy can be derived for graphical representation sub-channels when no such hierarchy has been created in file system directories. And when channel become too dense for intelligible visualization, segmentation into sub-channels is provided without user intervention (dimensioning sub-channel start times and endtimes).

Referring to FIG. 12, the invention further comprises methods for organizing at least one selectable graphical representation of an electronic artifact into a plurality of channels. That is the selectable graphical representation has both an executable link into a non-transitory medium as well as an icon suitable for a display device.

One aspect of the invention is having a geo-location associated with a channel of GPS tagged electronic artifacts. In an embodiment, two GPS coordinates may both define a center and a radius of a circular geo-location 1220. In an embodiment, more than two GPS coordinates may define a polygon border enclosing a geo-location 1240. The geo-location are thus positioned in latitude and longitude coordinate space. The third dimension is datetime 1203 so that a datetime attribute of each electronic artifact can be positioned within a channel between a start time and an end time. In one embodiment, the user or a default setting sets the start time 1222 and end time 1228. In an embodiment, electronic artifacts are automatically assigned into a channel when their datatime attribute falls within the start time and endtime of the channel. In another embodiment, the contents of electronic artifact 1243 assigned by a user to the channel configure the start time 1242 and the end time 1244.

At the same time, a content-dimensioned channel may be understood to occupy a cogno-location 1290 possibly related to user tags, or content, or pattern recognition. Again the datatime axis orders and positions the selectable graphical representations assigned to a cogno-channel 1291-1293. As an example, a video of a triathlete may be assigned both to the geo-location of an event as well as to a “Triathlons” cogno-location which includes electronic artifacts created at widely separated event locations. When the addition of a new graphical representation causes a channel to be over populated for distinguishability, a method automatically segments the channel and assigns timespans to each sub-channel to utilize the display resolution.

FIG. 12 is only oriented with time in a vertical orientation to assist in understanding of the principle of ordering. Conceptually, newer photographs fall on top of older photographs in stacks, the stacks positioned over hometowns, schools, places of employment, holiday, ceremony. Once rank ordering in datetime is understood as a method of cataloging, the visual display may be aligned horizontally or vertically in ascending or descending order. In best mode, the channels will display selectable graphical representations within timelines from left to right horizontally with newest to the right.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

FIG. 1 is a block diagram of an exemplary processor that may be used to perform one or more of the functions described herein. Referring to FIG. 1, processor 100 may comprise an exemplary client or server process. Processor 100 comprises a communication mechanism or bus 111 for communicating information, and a processor core 112 coupled with bus 111 for processing information. Processor core 112 comprises at least one processor core, but is not limited to a processor core, such as for example, ARM™, Pentium™, etc.

Processor 100 further comprises a random access memory (RAM), or other dynamic storage device 104 (referred to as main memory) coupled to bus 111 for storing information and instructions to be executed by processor 112. Main memory 104 also may be used for storing temporary variables or other intermediate information during execution of instructions by processor core 112.

Processor 100 also comprises a read only memory (ROM) and/or other static storage device 106 coupled to bus 111 for storing static information and instructions for processor core 112, and a non-transitory data storage device 107, such as a magnetic storage device or flash memory and its associated control circuits. Data storage device 107 is coupled to bus 111 for storing information and instructions.

Processor 100 may further be coupled to a display device 121 such a flat panel display, coupled to bus 111 for displaying information to a computer user. Voice recognition, optical sensor, motion sensor, microphone, keyboard, touch screen input, and pointing devices 123 may be attached to bus 111 or a wireless network interface 125 for communicating selections and command and data input to processor core 112.

### CONCLUSION

The present invention can be easily distinguished from a project management tool which requires a user to enter resource requirements and several times for each task and dependencies on other tasks. The present invention can be distinguished by having sub-channels for timespans to address a cluttered visualization. Left to right horizontal positioning of icons in chronologic order is easily noticeable.

A number of embodiments of the invention have been described. Nevertheless, it will be understood that various modifications may be made without departing from the spirit and scope of the invention. For example, other network topologies may be used. Accordingly, other embodiments are within the scope of the following claims.

1. A method for displaying a catalog of electronic artifacts in a file system in hierarchical chronological sequence comprising:
selecting at least one time attribute for each electronic artifact cataloged as a file object for relative rank ordering;
assigning each electronic artifact to at least one timeline corresponding to its reference in a directory of the file system;
determining a timespan attribute for each timeline according to a range of time attributes of electronic artifacts assigned to the timeline;
when a directory is contained inside another directory (a sub-directory), providing a graphical representation of said sub-directory as its timeline with indicia of timespan;
presenting in a user interface a plurality of selectable graphical representations of timelines in relative chronological position; and
presenting in a user interface, a selectable graphical representation of each timeline dimensioned according to the timespan attribute of the timeline.

2. The method of claim 1 further comprising:
receiving user selection of a graphical representation of a timeline;
presenting in chronologic order selectable graphical representations of sub-directories as timelines with indicia of timespan and selectable graphical representations of electronic artifacts assigned to said timeline; and
upon receiving user selection of retraction, presenting the immediate prior graphical representation.

3. The method of claim 1 further comprising:
upon passing a threshold count for graphical representations presented in a timeline,
segmenting a timeline into sub-timelines or reversing segmentation for visual comprehension.

4. The method of claim 1 further comprising:
upon receiving user dimensioning of timespans,
assigning electronic artifacts referenced in a directory into timelines according to their time attributes.

5. The method of claim 1 further comprising:
upon receiving calendar milestones derived from personal data of a user,
assigning electronic artifacts into timelines dimensioned by timespans mapped to said calendar milestones.

6. The method of claim 1 further comprising:
upon receiving user dimensioning of geo-fenced channels,
assigning electronic artifacts to channels according to Global Positioning System (GPS) coordinates within said geo-fenced channel; and
within each geo-fenced channel,
determining a timeline of electronic artifacts assigned to the geo-fenced channel.

7. The method of claim 1 further comprising:
upon receiving user dimensioning of a content channel,
assigning electronic artifacts to the channel according to image recognition, pattern matching, and key word filters; and
within each content channel,
determining a timeline of electronic artifacts assigned to the content channel.

8. A method for hierarchically displaying to a computer system user (user), a plurality of graphical representation of channels, a plurality of graphical representation of sub-channels, selectable icons and related executable links to storage locations in non-transitory media comprising:
receiving from a user interface timespans for each timeline of a sub-channel;
selecting a first group of electronic artifacts stored in non-transitory media according to their file access control meta data;
assigning to a first sub-channel selectable icons linked to the first group of electronic artifacts when their file access control meta data is within the timespan of the first sub-channel; and
upon selection of a sub-channel, displaying a timeline of selectable icons in chronologic order.

9. The method of claim 8 further comprising:
reading a stored location scope for a second sub-channel;
selecting a second group of electronic artifacts stored in non-transitory media according to their GPS tags;
assigning to a second sub-channel selectable icons linked to the second group of electronic artifacts when their GPS tags are within the range of the location scope of the second sub-channel; and
displaying a timeline of selectable icons in chronologic order.

10. The method of claim 8 further comprising:
receiving user dimensioned tags for a third sub-channel;
selecting a third group of electronic artifacts stored in non-transitory media according to user assigned tags associated with the electronic artifact;
assigning to a third sub-channel selectable icons linked to the third group of electronic artifacts when their user assigned tags match a user dimensioned tags; and
displaying a timeline of selectable icons in chronologic order.
